(19) United States
(12) Patent Application Publication
(10) Pub. No.: US 2002/0027304 A1
(43) Pub. Date: Mar. 7, 2002

(54) Agglomeration of alumina and binder therefor

(76) Inventors: Barry J. Robson, Riverton (AU); Ronald Gallagher, Atwell (AU)

Correspondence Address: ALCOA INC, ALCOA TECHNICAL CENTER, 100 TECHNICAL DRIVE, ALCOA CENTER, PA, 15069-0001, US

(21) Appl. No.: 09/895,544

(22) Filed: Jun. 29, 2001

(30) Foreign Application Priority Data
Mar. 1, 2001 (AU) PCT/AU01/00213
Mar. 28, 2000 (AU) PQ7546

(51) Int. Cl. B29B 9/00; C01F 7/02

(52) U.S. Cl. 264/12; 423/625

(57) ABSTRACT

A method for the agglomeration of alumina particles, the method comprising the steps of: adding a quantity of pseudo-boehmite to the alumina particles; and spray drying the mixture so formed to produce agglomerated granules.

### FIELD OF THE INVENTION

The present invention relates to a method for the agglomeration of particles of alumina, or particles containing a substantial portion of alumina, and a binder for use in such.

### BACKGROUND OF THE INVENTION

In the Bayer process for the extraction of alumina from alumina containing ores, precipitated alumina tri-hydrate is filtered, dried and calcined. This yields high purity alumina with a narrow range of particle sizes. However, a by-product of the calcination process is extremely fine particles of alumina, with an average size of less than 30 μm. This by-product is caught in the gas cleaning devices, including multi-cyclones, electrostatic precipitators and/or bag-houses, attached to the calcination device. Such particles are commonly known as ESP dust. In addition to being difficult to handle, ESP dust is difficult to reintroduce into the process stream, not being readily redigested in the highly caustic solution of the digestion phase.

Accordingly, it is desirable to be able to agglomerate small particles of alumina, such as ESP dust, to form coarser particles. Ideally, these coarser particles are of a size range suitable for use in aluminium smelting.

In the ceramics industry, particles are agglomerated by spray drying using organic polymers as binders. However, the agglomerates formed by these methods are typically weakly bonded and they are readily degraded when handled or transported.

In Australian Patent 664328, there is provided a method for agglomerating alumina particles with a binder comprising a polymer form of a hydroxy salt of aluminium. In a variant of the invention, activated alumina is used to reduce the quantities of the binding agent required. The activated alumina is believed to enhance binding by forming a film of pseudo boehmite that adheres to the particles of unactivated alumina powder. However, it is clearly stated that the activated alumina cannot be used alone to achieve beneficial agglomeration of the alumina particles.

However the cost of the binding agent, and that associated with the production of activated alumina, have prevented the widespread application of this method. It is one object of the present invention to provide a method for the agglomeration of particles of alumina, or particles comprising alumina, where the quantity of binder required is substantially reduced, and the need for activated alumina eliminated.

The preceding discussion of the background to the invention is intended to facilitate an understanding of the present invention. However, it should be appreciated that the discussion is not an acknowledgement or admission that any of the material referred to was part of the common general knowledge in Australia as at the priority date of the application.

Throughout the specification, unless the context requires otherwise, the word “alumina” will be understood to encompass fully dehydrated alumina, fully hydrated alumina, partially hydrated alumina or a mixture of these forms.

Throughout the specification, unless the context requires otherwise, the term “alumina particles” will be understood to include particles of an alumina containing material where the alumina content of said particles is at least about 30% by weight Al₂O₃.

Further, throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention, there is provided a method for the agglomeration of alumina particles, the method comprising the steps of:

adding a quantity of pseudo-boehmite to the alumina particles; and

spray drying the mixture so formed to produce agglomerated granules.

Preferably, the pseudo-boehmite is added as an aqueous suspension.

Preferably, the aqueous suspension of pseudo-boehmite is formed at a temperature between about 15 and 100° C. Preferably still, the aqueous suspension of pseudo-boehmite is formed at a temperature above about 80° C. In a highly preferred form of the invention, the aqueous suspension of pseudo-boehmite is formed at a temperature above about 85° C.

Preferably, a quantity of acid is added to the aqueous suspension of pseudo-boehmite such that the pH of such is between about 2 and 6. Advantageously, a quantity of acid is added to the aqueous suspension of pseudo-boehmite such that the pH of such is approximately 3. Preferably, the acid is monoprotic. In a highly preferred form of the invention, the acid is acetic acid.

Preferably, before the step of adding a quantity of pseudo-boehmite to the alumina particles, the present invention comprises the step of comminuting the alumina particles to a D₅₀ of less than 12 μm. Preferably, the alumina particles are comminuted to a D₅₀ of less than about 9 μm. In a highly preferred form of the invention, the alumina particles are comminuted to a D₅₀ of about 5 μm.

The alumina particles may be comminuted by jet milling or by grinding means involving cermaic or metal grinding media including ball milling and bead milling.

In one form of the invention, a quantity of water is added to the alumina particles to form a slurry, the slurry then being subjected to grinding.

In an alternate form of the invention, the alumina particles are subjected to dry grinding before a quantity of water is added to form a slurry. Where the alumina particles are subjected to dry grinding before a quantity of water is added to form a slurry, the quantity of water may be provided by way of the aqueous suspension of pseudo-boehmite.

Preferably, the slurry is of as high a density as possible. Preferably still the slurry comprises at least 50% solids. Typically, the slurry comprises between about 40 and 60% solids.

The slurry may also contain a viscosity modifier. The viscosity modifier may be one or more of acetic acid, citric acid or a polyacrylate. Preferably, sufficient viscosity modifier is added such that the viscosity of the slurry is less than about 4 cp. In a preferred form of the invention, the viscosity modifier is acetic acid. In a highly preferred form of the invention, sufficient acetic acid is introduced such that the concentration of the acetic acid in the slurry is between about 0.2 and 1.5% by weight of the alumina particles.

Preferably, before the quantity of pseudo-boehmite is added to the alumina particles, the method comprises the additional steps of:

neutralising, dewatering and washing the alumina particles.

In one form of the invention, dewatering is achieved by way of filtration. In an alternate form of the invention, dewatering may be achieved by way of centrifugation. Preferably, carbon dioxide is used to neutralise the alumina particles.

The step of neutralising, dewatering and washing the alumina particles may be carried out before or after grinding the alumina particles. Conveniently, the step of neutralising, dewatering and washing the alumina particles is carried out before the step grinding the alumina particles as a smaller filter may be used.

The method of the present invention may comprise the additional step of:

heating the agglomerated granules.

In one form of the invention, the agglomerated particles are dehydroxylated by heating to approximately 300° C. In an alternate form of the invention, the agglomerated granules are calcined above 500° C.

### BEST MODE(S) FOR CARRYING OUT THE INVENTION

The method of the present invention will subsequently be described, by way of example only, with reference to one embodiment thereof and several examples.

In the embodiment, a quantity of water is added to particulate alumina to form a slurry of a density between about 40 and 60% solids. A viscosity modifier, in the form of acetic acid is added to the slurry such that the concentration of acetic acid in the slurry is between about 0.2 and 1.5% by weight of the alumina particles.

The slurry is then subjected to grinding such that the alumina particles are ground to a D₅₀ of less than 12 μm and preferably about 5 μm.

A quantity of binding agent in the form of an aqueous suspension of pseudo boehmite is added to the slurry.

The aqueous suspension of pseudoboehmite is formed at a temperature above about 80° C., and preferably above about 85° C. A quantity of monoprotic acid, preferably acetic acid, is added to the aqueous suspension of pseudo boehmite such that the pH is about 3.0.

The mixture formed by the addition of the aqueous suspension of pseudo boehmite to the slurry is then spray dried to produce agglomerated granules.

The agglomerated granules may then be heated to in excess of approximately 300° C. to effect dehydroxylation of such, or in excess of approximately above 500° C. to effect calcination of such.

The present invention will now be described by way of several examples. However, it must be appreciated that the following description of those examples is not to limit the generality of the above description of the invention.

### EXAMPLE 1

One kilogram of alumina particles with a D₅₀ of 15.3 μm was added to 1200 mL of water to form a slurry. Carbon dioxide gas was bubbled through the slurry until the pH of such was about 6.5. Glacial acetic acid (5 g) was added to the slurry, which was then heated to 85° C.

A quantity of a pseudo-boehmite suspension was added to the slurry. The pseudo-boehmite suspension was prepared by the dispersion of 50 g of a commercial pseudo-boehmite (either Catapal B (supplied by Vista Condea) or HiQ X (supplied by Alcoa World Chemicals)) in 200 g of 85° C. water. After the mix returned to 85° C., 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 2

One kilogram of alumina particles with a D₅₀ of 15.3 μm was added to 1200 mL of water to form a slurry. Carbon dioxide gas was bubbled through the slurry until the pH of such was about 6.5. The slurry was filtered and washed with a further 500 mL of water. The filter cake was then re-slurried in sufficient water to produce a slurry containing 50% solids. Glacial acetic acid (5g) was added to the final slurry, which was then heated to 85° C.

A quantity of a pseudo-boehmite suspension was added to the slurry. The pseudo-boehmite suspension was prepared by the dispersion 50 g of a commercial pseudo-boehmite (either Catapal B (supplied by Vista Condea) or HiQ X (supplied by Alcoa World Chemicals)) in 200 g of 85° C. water. After the mix returned to 85° C., 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 3

One kilogram of alumina particles with a D₅₀ of 15.3 μm was added to 1200 mL of water to form a slurry. Carbon dioxide gas was bubbled through the slurry until the pH of such was about 6.5. The slurry was filtered and washed with a further 500 mL of water. The filter cake was then re-slurried in sufficient water to produce a slurry containing 50% solids. Glacial acetic acid (5 g) was added to the final slurry, which was then heated to 85° C.

A quantity of a pseudo-boehmite suspension was added to the slurry. The pseudo-boehmite suspension was prepared by the dispersion 20 μm of a commercial pseudo-boehmite (either Catapal B (supplied by Vista Condea) or HiQ X (supplied by Alcoa World Chemicals)) in 200 g of 85° C. water. After the mix returned to 85° C., 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 4

Alumina particles with a D₅₀ of 15.3 μm were slurried in water. Carbon dioxide gas was bubbled through the slurry until the pH of such was about 6.5. The slurry was filtered and washed with a further 500 mL of water, then dried. The powder was then dry ground in a Jet Mill. One kilogram of the ground alumina particles was added to 800 mL of water to form a slurry. Glacial acetic acid (5 g) was added to the final slurry, which was then heated to 85° C.

A quantity of a pseudo-boehmite suspension was added to the slurry. The pseudo-boehmite suspension was prepared by the dispersion 10 gm of a commercial pseudo-boehmite (either Catapal B (supplied by Vista Condea) or HiQ X (supplied by Alcoa World Chemicals)) in 200 g of 85° C. water. After the mix returned to 85° C. 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 5

Alumina particles with a D₅₀ of 15.3 μm were slurried in water. Carbon dioxide gas was bubbled through the slurry until the pH of such was about 6.5. The slurry was filtered and washed with a further 500 mL of water, then dried. The powder was then dry ground in a Jet Mill. One kilogram of the ground alumina particles was added to 620 mL of water to form a slurry. Glacial acetic acid (4.4 g) was added to the final slurry, which was then heated to 85° C.

A quantity of a pseudo-boehmite suspension was added to the slurry. The pseudo-boehmite suspension was prepared by the dispersion 10 gm of a commercial pseudo-boehmite (either Catapal B (supplied by Vista Condea) or HiQ X (supplied by Alcoa World Chemicals)) in 200 g of 85° C. water. After the mix returned to 85° C., 0.7 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 6

Alumina particles with a D₅₀ of 15.3 μm were slurried in water. Carbon dioxide gas was bubbled through the slurry until the pH of such was about 6.5. The slurry was filtered and washed with a further 500 mL of water, then dried. The powder was then dry ground in a Jet Mill. One kilogram of the ground alumina particles was added to 800 mL of water to form a slurry. Glacial acetic acid (5 g) was added to the final slurry, which was then heated to 85° C.

A quantity of a pseudo-boehmite suspension was added to the slurry. The pseudo-boehmite suspension was prepared by the dispersion 20 gm of a commercial pseudo-boehmite (either Catapal B (supplied by Vista Condea) or HiQ X (supplied by Alcoa World Chemicals)) in 200 g of 85° C. water. After the mix returned to 85° C., 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 7

One kilogram of alumina particles with a D₅₀ of 15.3 μm was added to 800 mL of water to form a slurry. Carbon dioxide gas was bubbled through the slurry until the pH of such was about 6.5.Glacial acetic acid (5 g) was added to the slurry, which was then heated to 85° C. This slurry was ground for 30 minutes in a laboratory jar mill.

A quantity of a pseudo-boehmite suspension was added to the slurry. The pseudo-boehmite suspension was prepared by the dispersion 20 gm of a commercial pseudo-boehmite (either Catapal B (supplied by Vista Condea) or HiQ X (supplied by Alcoa World Chemicals)) in 200 g of 85° C. water. After the mix returned to 85° C., 5 g of glacial acetic acid was added.

After mixing for several minutes the slurry to which the pseudo-boehmite suspension was added were then spray dried. Throughout the spray drying the off gas temperature was maintained at 180° C. Portions of the product were calcined at 500° C. in a muffle furnace for one hour.

### EXAMPLE 8

One kilogram of alumina particles with a D₅₀ of 15.3 μm was added to 1200 mL of water to form a slurry. Carbon dioxide gas was bubbled through the slurry until the pH of such was about 6.5. The slurry was filtered and deliquored. The filter cake was then reslurried in sufficient water to produce a slurry containing 50% solids. Glacial acetic acid (5 g) was added to the final slurry, which was then heated to 85° C. This slurry was ground for 30 minutes in a laboratory jar mill.

A quantity of a pseudo-boehmite suspension was added to the slurry. The pseudo-boehmite suspension was prepared by the dispersion 20 gm of a commercial pseudo-boehmite (either Catapal B (supplied by Vista Condea) or HiQ X (supplied by Alcoa World Chemicals)) in 200 g of 85° C. water. After the mix returned to 85° C. 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 9

One kilogram of alumina particles with a D₅₀ of 15.3 μm was added to 1200 mL of water to form a slurry. Carbon dioxide gas was bubbled through the slurry until the pH of such was about 6.5. The slurry was filtered and washed with a further 500 mL of water. The filter cake was then reslurried in sufficient water to produce a slurry containing 50% solids. Glacial acetic acid (5 g) was added to the slurry, which was then heated to 85° C. This slurry was ground for 30 minutes in a laboratory jar mill.

A quantity of a pseudo-boehmite suspension was added to the slurry. The pseudo-boehmite suspension was prepared by the dispersion 8 gm of a commercial pseudo-boehmite (either Catapal B (supplied by Vista Condea) or HiQ X (supplied by Alcoa World Chemicals)) in 200 g of 85° C. water. After the mix returned to 85° C. 5 g of glacial acetic acid was added.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 10

Alumina particles with a D₅₀ of 15.3 μm were slurried in water. Carbon dioxide gas was bubbled through the slurry until the pH of such was about 6.5. The slurry was filtered and washed with a further 500 mL of water, then dried. The powder was then dry ground in a Jet Mill. One kilogram of the ground alumina particles was added to 800 mL of water to form a slurry. Glacial acetic acid (5 g) was added to the final slurry.

A quantity of a pseudo-boehmite suspension was added to the slurry. The pseudo-boehmite suspension was prepared by the dispersion 40 gm of a commercial pseudo-boehmite (either Catapal B (supplied by Vista Condea) or HiQ X (supplied by Alcoa World Chemicals)) in 200 g of water at room temperature. 5 g of glacial acetic acid was added to this mix.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

### EXAMPLE 11

Alumina particles with a D₅₀ of 15.3 μm were slurried in water. Carbon dioxide gas was bubbled through the slurry until the pH of such was about 6.5. The slurry was filtered and washed with a further 500 mL of water, then dried. The powder was then dry ground in a Jet Mill. One kilogram of the ground alumina particles was added to 800 mL of water to form a slurry. Glacial acetic acid (5 g) was added to the final slurry.

A quantity of a pseudo-boehmite suspension was added to the slurry. The pseudo-boehmite suspension was prepared by the dispersion 20 gm of a commercial pseudo-boehmite (either Catapal B (supplied by Vista Condea) or HiQ X (supplied by Alcoa World Chemicals)) in 200 g of water. 5 g of glacial acetic acid was added to the mix.

After mixing for several minutes the slurry to which the pseudo-boehmite suspension was added was then spray dried. Throughout the spray drying the off gas temperature was maintained at 180° C. Portions of the product were calcined at 500° C. in a muffle furnace for one hour.

A summary of the test conditions for Examples 1 to 11 appears in Table 1, below.

TABLE 1

| | | | | | SD | | |
|---|---|---|---|---|---|---|---|
| | Dust | | | | Feed | | Peptise |
| | D50 | | | How | D50, | Binder | T, |
| Example | (μm) | Filtered | Washed | Milled | (μm) | (%) | (° C.) |
| 1 | 15.3 | No | No | No | 15.3 | 5 | 85 |
| 2 | 15.3 | Yes | Yes | No | 15.3 | 5 | 85 |
| 3 | 15.3 | Yes | Yes | No | 15.3 | 2 | 85 |
| 4 | 15.3 | Yes | Yes | Dry | 4.6 | 1.0 | 85 |
| 5 | 15.3 | yes | yes | Dry | 4.6 | 1.0 | 85 |
| 6 | 15.3 | Yes | Yes | Dry | 4.6 | 2.0 | 85 |
| 7 | 15.3 | No | No | Wet | 5.0 | 2.0 | 85 |
| 8 | 15.3 | Yes | No | Wet | 5.3 | 2.0 | 85 |
| 9 | 15.3 | Yes | Yes | Wet | 5.4 | 0.8 | 85 |
| 10 | 15.3 | Yes | Yes | Dry | 4.6 | 4.0 | 20 |
| 11 | 15.3 | Yes | Yes | Dry | 4.6 | 2.0 | 20 |

Product samples were analysed for soda content so as to distinguish the effect of washing the feed dust, as it was suspected that soda content may adversely affect boehmitic gel formation. The results of the soda content analyses of the agglomerates appear in Table 2, below

TABLE 2

| Example | 1 | 2, 3 | 4, 5, 6, 10, 11 | 7 | 8 | 9 |
|---|---|---|---|---|---|---|
| % soda | 0.78 | 0.33 | 0.27 | 0.77 | 0.30 | 0.33 |

Samples of the micro agglomerates were analysed for particle size distribution. The results of the particle size distribution analysis are given in Table 3, below. For comparative purposes the size analysis of regular smelting grade alumina (SGA) is also included.

TABLE 3

| Cumulative | | | | | | | |
|---|---|---|---|---|---|---|---|
| percent passing | 1000 | 300 | 212 | 150 | 106 | 75 | 53 |
| size | μm | μm | μm | μm | μm | μm | μm |
| Example 1 | 100 | 79.8 | 54.4 | 35.5 | 21.4 | 16.3 | 13.7 |
| Example 2 | 100 | 84.2 | 61.2 | 36.7 | 15.5 | 5.7 | 2.1 |
| Example 3 | 100 | 82.7 | 58.3 | 34.0 | 13.6 | 4.6 | 1.4 |
| Example 4 | 100 | 85.5 | 58.3 | 32.3 | 12.9 | 3.9 | 1.0 |
| Example 5 | 100 | 87.4 | 69.5 | 47.7 | 24.0 | 9.0 | 2.6 |
| Example 6 | 100 | 83.0 | 51.8 | 27.8 | 10.9 | 3.9 | 1.4 |
| Example 7 | 100 | 63.1 | 33.8 | 16.7 | 6.8 | 4.2 | 3.5 |
| Example 8 | 100 | 77.7 | 49.2 | 27.7 | 10.6 | 2.4 | 0.3 |
| Example 9 | 100 | 91.2 | 72.2 | 48.1 | 24.6 | 9.5 | 2.8 |
| Example 10 | 100 | 89.9 | 62.4 | 37.6 | 16.6 | 5.7 | 1.7 |
| Example 11 | 100 | 92.3 | 67.7 | 38.0 | 16.1 | 5.9 | 1.9 |
| SGA1 | 100 | 99.9 | 99.7 | 95.3 | 70.1 | 34.8 | 13.8 |
| SGA2 | 100 | 100 | 100 | 94.4 | 42.7 | 15.0 | 4.8 |

In all cases the micro agglomerates formed are of a size slightly coarser than smelting grade alumina, but which is acceptable for the end use.

The micro agglomerates were also tested for strength using an attrition test wherein 25 g of micro agglomerate was placed on the top screen in a stack on a RoTap shaker, and the shaker was activated for 5 minutes. A separate sample was placed on the shaker for 20 minutes. The difference in particle size distribution was used as a comparative breakage test for the samples. The results were compared to a sample of smelting grade alumina. The results of this testing are given in Tables 4 and 5. Table 4, below, shows the results of the attrition testing conducted on the discharge from the spray dryer.

TABLE 4
Screen size

| | | | | | | |
|---|---|---|---|---|---|---|
| 300 | 212 | 150 | 106 | 75 | 53 | −53 |
| μm | μm | μm | μm | μm | μm | μm |

(Change in percent of material retained on
screen between 5 and 20 minute shaking)

| | | | | | | | |
|---|---|---|---|---|---|---|---|
| Example 1 | −19.7 | −25.2 | −17.8 | −0.6 | 1.2 | 0.6 | 61.4 |
| Example 2 | −2.9 | −0.7 | 1.1 | 0.9 | 0.3 | 0.1 | 1.2 |
| Example 3 | −16.9 | −16.4 | 9.2 | 4.6 | 1.9 | 1.0 | 16.6 |
| Example 4 | −1.7 | −1.2 | 0.8 | 1.2 | 0.4 | 0.2 | 0.4 |
| Example 5 | −2.2 | −.1 | 0.5 | 0.7 | 0.1 | 0.2 | 0.9 |
| Example 6 | −2.3 | 0.3 | 0.8 | 0.4 | 0.1 | 0.3 | 0.5 |
| Example 7 | −36.0 | −28.7 | −14.0 | 11.4 | −0.1 | 1.3 | 66.1 |
| Example 8 | −7.5 | 1.4 | 2.2 | 1.1 | 0.6 | 0.4 | 1.7 |
| Example 9 | −1.4 | −0.9 | 0.5 | 0.6 | 0.2 | −0.1 | 1.2 |
| Example 10 | −0.6 | −0.4 | 0.2 | 0.1 | 0.1 | 0.2 | 0.4 |
| Example 11 | −5.3 | 0.9 | 1.6 | 0.8 | 0.2 | 0.1 | 1.7 |
| SGA1 | −0.1 | −0.1 | −0.5 | −0.5 | −0.4 | 0 | 1.7 |
| SGA 2 | 0 | 0 | −0.5 | −1.1 | 1.0 | 0 | 0.7 |

Of particular interest is the increase in the finest portion of the measured particle size distribution (53 μm) and we can see that the micro agglomerates produced in examples 2, 4, 5, 6, 8 and 9 are of comparable attrition resistance to smelting grade alumina. Examples 10 and 11 demonstrated acceptable attrition resistance.

On the basis of these results it was determined that the product of examples 1, 3 and 7 had unsatisfactory attrition resistance and no further testing was conducted. The attrition test results of the paired Examples 1 and 2 and also 7 and 8 suggest that the soluble soda levels of the alumina dust must be reduced before this pseudo-boehmite binding system can be effectively applied. Apparently the presence of soluble salts interferes with the peptisation of the pseudo-boehmite.

A comparison of examples 2 and 3 with examples 6 and 8 show that to produce attrition resistant product a higher binder level (5% for example 2, 2% in examples 3, and 6) is required with coarser dusts.

Table 5, below, shows the results of the attrition testing for micro agglomerates which have been calcined to 500° C.

TABLE 5
Screen size

| | | | | | | |
|---|---|---|---|---|---|---|
| 300 | 212 | 150 | 106 | 75 | 53 | −53 |
| μm | μm | μm | μm | μm | μm | μm |

(Change in percent of material retained on
screen between 5 and 20 minute shaking)

| | | | | | | | |
|---|---|---|---|---|---|---|---|
| Example 2 | −6.6 | 1.0 | 2.1 | 1.2 | 0.6 | 0.3 | 1.4 |
| Example 4 | −1.8 | −1.3 | 0.9 | 1.2 | 0.4 | 0.2 | 0.4 |
| Example 5 | −9.4 | −4.1 | 3.3 | 4.1 | 1.0 | 1.0 | 4.0 |
| Example 6 | −10.9 | 3.1 | 3.6 | 1.4 | 0.8 | 0.3 | 1.7 |
| Example 8 | −15.8 | 4.8 | 4.6 | 2.1 | 0.9 | 0.8 | 2.7 |
| Example 9 | −5.8 | −1.6 | 2.5 | 2.0 | 1.0 | 0.4 | 1.5 |
| Example 10 | −2.0 | −0.6 | 0.8 | 0.9 | 0.3 | 0.1 | 0.5 |
| Example 11 | −5.9 | −19.4 | −9.8 | 11.5 | 3.3 | 2.5 | 17.8 |
| SGA1 | −0.1 | −0.1 | −0.5 | −0.5 | −0.4 | 0 | 1.7 |
| SGA 2 | 0 | 0 | −0.5 | −1.1 | 1.0 | 0 | 0.7 |

Calcination to 500° C. dehydroxylates any gibbsite which may be present in the dust, and the added pseudo-boehmite. Attrition resistance remains generally acceptable. Whilst demonstrating acceptable attrition resistance down to the 2% binder level before calcination, Examples 10 and 11 showed unsatisfactory attrition resistance below 4% binder concentration after calcination. In Examples 10 and 11 the alumina particles were peptised at 20° C.

Another set of experiments demonstrated the effect of comminuting alumina particles before they are combined with a binder. ESP dust was collected and milled in a Hosokawa Alpine Jet Mill. The analysis of the treated ESP dust appears in Table 6 below.

TABLE 6

| | | | | | | % Loss | % Loss | |
|---|---|---|---|---|---|---|---|---|
| | | | | | % Loss | 105- | 300- | Total % |
| | % Na₂O | D₁₀ | D₅₀ | D₉₀ | to 105° C. | 300° C. | 950° C. | loss |
| As Collected | 0.61 | 3.7 | 13.9 | 35.6 | | | | |
| As Treated | 0.27 | 2.0 | 3.0 | 5.7 | 1.17 | 16.04 | 4.05 | 21.26 |

A slurry of water, poly aluminum hydroxy chloride (PAC) binder and the treated ESP dust was prepared to a solids density of approximately 50%. The slurry was then spray dried to form micro agglomerates under the conditions set out in Table 7 below.

TABLE 7

| % | | Spray Dryer Exhaust |
|---|---|---|
| PAC | pH | Temperature, ° C. |
| 10 | 3.8 | 138.5 |
| 7 | 4.2 | 130 |
| 5 | 5.1 | 130 |
| 4 | 5.5 | 145 |
| 3 | 5.3 | 145 |
| 2 | 6.2 | 145 |

Six runs were conducted at different PAC addition levels. Agglomeration was noted in all cases. Particle size distribution analyses were conducted on the micro agglomerates. The particle size distribution (by screening) of the product is shown in Table 8 below.

TABLE 8

| Cumulative % | 1000 | 500 | | | | |
|---|---|---|---|---|---|---|
| passing size | μm | μm | 300 μm | 212 μm | 106 μm | 45 μm |
| 10% PAC | 100 | 95.3 | 90.2 | 80.5 | 33.5 | 2.8 |
| 7% PAC | 100 | 95.3 | 89.0 | 80.1 | 31.8 | 2.4 |
| 5% PAC | 100 | 96.5 | 89.0 | 72.4 | 24.6 | 1.6 |
| 4% PAC | 100 | 95.8 | 84.0 | 62.3 | 20.2 | 1.1 |
| 3% PAC | 100 | 89.5 | 78.4 | 59.1 | 19.3 | 0.9 |
| 2% PAC | 100 | 89.3 | 71.9 | 75.7 | 5.2 | 0.2 |

As can be seen, the product micro agglomerates are similar to the desired smelting grade alumina sizing.

The micro agglomerates produced were tested for strength using an attrition test wherein 10 g of micro agglomerate was placed on the top screen in a stack on a Rop Tap, shaker and the shaker was activated for 5 minutes. A separate sample was placed on the shaker for 20 minutes. The difference in particle size distribution was used as a comparative breakage test for the samples. The results of the attrition test conducted on agglomerates formed with 7% PAC appear in Table 9 below.

TABLE 9

| | Not Calcined | | | 600° C. | | | 900° | | |
|---|---|---|---|---|---|---|---|---|---|
| | 5 | 20 | | 5 | 20 | | 5 | 20 | |
| Time | min. | min. | delta | min. | min. | delta | min. | min | delta |
| Size | % Retained | | | | | | | | |
| (mic) | | | | | | | | | |
| +300 | 6.47 | 4.44 | −2.03 | 4.44 | 2.11 | −2.33 | 3.91 | 1.58 | −2.33 |
| −300/ | 9.88 | 10.55 | 0.67 | 9.11 | 9.03 | −0.08 | 11.04 | 10.02 | −1.02 |
| +212 | | | | | | | | | |
| −212/ | 23.42 | 23.92 | 0.49 | 23.36 | 23.44 | 0.07 | 26.15 | 26.50 | 0.34 |
| +150 | | | | | | | | | |
| −150/ | 26.75 | 27.01 | 0.27 | 29.00 | 28.30 | −0.70 | 29.27 | 30.15 | 0.88 |
| +106 | | | | | | | | | |
| −106/ | 16.64 | 16.79 | 0.15 | 17.39 | 18.29 | 0.90 | 16.41 | 17.26 | 0.84 |
| +75 | | | | | | | | | |
| −75/ | 9.29 | 8.94 | −0.36 | 9.13 | 9.52 | 0.39 | 7.81 | 7.94 | 0.13 |
| +53 | | | | | | | | | |
| −53 | 7.54 | 8.35 | 0.81 | 7.57 | 9.31 | 1.74 | 5.40 | 6.56 | 1.16 |

The results of the attrition tests conducted on agglomerates formed with 5% PAC appear in Table 10 below.

TABLE 10

| | Not Calcined | | | 600° C. | | | 900° C. | | |
|---|---|---|---|---|---|---|---|---|---|
| | 5 | 20 | | 5 | 20 | | 5 | 20 | |
| Time | min. | min. | delta | min. | min. | delta | min. | min. | delta |
| Size (mic) | % Retained | | | | | | | | |
| +300 | 7.67 | 4.99 | −2.69 | 2.02 | 0.19 | −1.83 | 1.65 | 0.18 | −1.47 |
| −300/+212 | 15.74 | 16.71 | 0.97 | 14.56 | 10.32 | −4.24 | 15.13 | 4.50 | −10.63 |
| −212/+150 | 25.92 | 26.65 | 0.73 | 26.35 | 29.14 | 2.80 | 26.92 | 33.93 | 7.01 |
| −150/+106 | 24.78 | 25.14 | 0.36 | 27.03 | 28.33 | 1.30 | 26.86 | 29.13 | 2.27 |
| −106/+75 | 13.96 | 13.93 | −0.03 | 15.55 | 16.02 | 0.47 | 15.54 | 16.24 | 0.70 |
| −75/+53 | 7.18 | 7.08 | −0.10 | 8.44 | 8.48 | 0.04 | 8.03 | 8.42 | 0.39 |
| −53 | 4.74 | 5.50 | 0.77 | 6.05 | 7.51 | 1.47 | 5.89 | 7.62 | 1.73 |

The results of the attrition tests conducted on agglomerates formed with 3% PAC appear in Table 11 below.

TABLE 11

| | Not Calcined | | |
|---|---|---|---|
| | 5 | 20 | |
| Time | min. | min. | delta |
| Size (mic) | % Retained | | |
| +300 | 19.34 | 8.87 | −10.47 |
| −300/+212 | 19.77 | 21.66 | 1.90 |
| −212/+150 | 22.16 | 27.33 | 5.17 |
| −150/+106 | 21.43 | 23.57 | 2.14 |
| −106/+75 | 9.46 | 9.60 | 0.14 |
| −75/+53 | 5.46 | 5.61 | 0.14 |
| −53 | 2.38 | 3.36 | 0.98 |

The results of the attrition tests conducted on agglomerates formed with 10% PAC appear in Table 12 below.

TABLE 12

| | Not Calcined | | | 600° C. | | | 900° C. | | |
|---|---|---|---|---|---|---|---|---|---|
| | 5 | 20 | | 5 | 20 | | 5 | 20 | |
| Time | min. | min. | Delta | min. | min. | delta | min. | min. | delta |
| Size | % Retained | | | | | | | | |
| (mic) | | | | | | | | | |
| +300 | 6.05 | 4.82 | −1.23 | 4.34 | 2.37 | −2.00 | 3.38 | 1.36 | −2.02 |
| −300/ | 11.40 | 8.78 | −2.62 | 7.81 | 7.53 | −0.29 | 7.65 | 7.24 | −0.41 |
| +212 | | | | | | | | | |
| −212/ | 19.92 | 20.86 | 0.94 | 19.14 | 19.39 | 0.25 | 18.62 | 18.98 | 0.36 |
| +150 | | | | | | | | | |
| −150/ | 26.23 | 27.20 | 0.97 | 28.06 | 28.11 | 0.04 | 27.24 | 27.79 | 0.56 |
| +106 | | | | | | | | | |
| −106/ | 17.39 | 18.05 | 0.66 | 19.31 | 19.49 | 0.18 | 19.25 | 19.69 | 0.43 |
| +75 | | | | | | | | | |
| −75/ | 10.30 | 10.21 | −0.09 | 10.88 | 11.11 | 0.23 | 11.84 | 11.69 | −0.15 |
| +53 | | | | | | | | | |
| −53 | 8.71 | 10.07 | 1.36 | 10.46 | 12.01 | 1.55 | 12.02 | 13.25 | 1.23 |

The results of the attrition tests conducted on aglomerates formed with 4% PAC appear in Table 13 below.

TABLE 13

| | Not Calcined | | | 600° C. | | | 900° C. | | |
|---|---|---|---|---|---|---|---|---|---|
| | 5 | 20 | | 5 | 20 | | 5 | 20 | |
| Time | min. | min. | delta | min. | min. | delta | min. | min. | Delta |
| Size (mic) | % Retained | | | | | | | | |
| +300 | 13.02 | 10.72 | −2.30 | 5.25 | 0.20 | −5.05 | 2.938 | 0.24 | −2.70 |
| −300/+212 | 22.13 | 23.06 | 0.93 | 24.28 | 14.42 | −9.86 | 27.37 | 11.24 | −13.13 |
| −212/+150 | 23.47 | 23.92 | 0.45 | 24.92 | 33.95 | 9.02 | 26.18 | 36.16 | 9.98 |
| −150/+106 | 21.91 | 22.18 | 0.27 | 23.00 | 25.98 | 2.98 | 23.92 | 26.85 | 2.93 |
| −106/+75 | 10.53 | 10.25 | −0.28 | 11.70 | 11.10 | −0.60 | 11.34 | 11.06 | −0.28 |
| −75/+53 | 5.73 | 5.89 | 0.15 | 5.69 | 6.16 | 0.47 | 5.91 | 5.80 | −0.12 |
| −53 | 3.20 | 3.98 | 0.78 | 5.16 | 8.19 | 3.03 | 5.33 | 8.66 | 3.33 |

The results of the attrition tests conducted on agglomerates formed with 2% PAC appear in Table 14 below.

TABLE 14

| | Not Calcined | | |
|---|---|---|---|
| Time | 5 | 20 | |
| Size | min. | min. | delta |
| (microns) | % Retained | | |
| +300 | 19.65 | 11.52 | −8.13 |
| −300/+212 | 30.03 | 18.13 | −11.90 |
| −212/+150 | 24.81 | 29.85 | 5.04 |
| −150/+106 | 14.64 | 23.52 | 8.87 |
| −106/+75 | 4.81 | 4.80 | −0.01 |
| −75/+53 | 3.72 | 7.01 | 3.29 |
| −53 | 2.32 | 5.17 | 2.85 |

The results were compared to micro agglomerates formed using unground ESP and 10% PAC. The results of the attrition tests conducted on agglomaerates formed with 10% PAC and unground ESP dust appear in Table 15 below.

TABLE 15

| | Not Calcined | | | 600° C. | | | 900° C. | | |
|---|---|---|---|---|---|---|---|---|---|
| | 5 | 20 | | 5 | 20 | | 5 | 20 | |
| Time | min. | min. | delta | min. | min. | delta | min. | min. | delta |
| Size | % Retained | | | | | | | | |
| (mic) | | | | | | | | | |
| +300 | 4.12 | 3.26 | −0.86 | 0.82 | 0.49 | −0.33 | 0.79 | 0.29 | −0.50 |
| −300/ | 6.17 | 6.01 | −0.16 | 6.16 | 5.07 | −1.09 | 5.84 | 4.43 | −1.41 |
| +212 | | | | | | | | | |
| −212/ | 15.64 | 15.84 | 0.19 | 16.11 | 15.83 | −0.27 | 15.84 | 15.62 | −0.23 |
| +150 | | | | | | | | | |
| −150/ | 25.57 | 25.45 | −0.12 | 28.62 | 28.90 | 0.28 | 29.15 | 29.64 | 0.49 |
| +106 | | | | | | | | | |
| −106/ | 20.44 | 20.51 | 0.068 | 24.27 | 24.19 | −0.08 | 23.99 | 24.27 | 0.28 |
| +75 | | | | | | | | | |
| −75/ | 13.61 | 13.13 | −0.48 | 15.91 | 15.34 | −0.57 | 15.90 | 15.22 | −0.68 |
| +53 | | | | | | | | | |
| −53 | 14.43 | 15.8 | 1.37 | 8.10 | 10.17 | 2.07 | 8.49 | 10.54 | 2.05 |

The results were compared to the attrition behavior of a typical smelting grade alumina. Results of the attrition test conducted on a typical smelting grade alumina appear in Table 16 below.

TABLE 16

| Attrition | | | |
|---|---|---|---|
| Time, | | | |
| (min) | | | |
| Size | 5 | 20 | |
| Range, | min. | min. | delta |
| microns | % Retained | | |
| +300 | 0.15 | 0.02 | −0.13 |
| −300/+212 | 0.13 | 0.00 | −0.13 |
| −212/+150 | 4.48 | 3.94 | −0.54 |
| −150/+106 | 25.15 | 24.67 | −0.48 |
| −106/+75 | 35.33 | 34.92 | −0.41 |
| −75/+53 | 20.96 | 20.97 | 0.00 |
| −53 | 13.80 | 15.48 | 1.68 |
| | 100.00 | 100.00 | |

The results demonstrate that before calcination, the products of mixes containing greater than 4% PAC binder have comparable resistance to the product of the unground ESP with 10% PAC binder. After heating to 600° C., there is more breakage of coarse particles at the 5% PAC level, and considerably more at the 4% PAC level. Most of this material goes into the 106 to 212 μm range and there is only a small increase in the smallest fraction measured. After heating to 900° C., there is much more breakage from the coarse fractions of the 4% PAC and 5% PAC samples than the product of the unground ESP. Again, most of this material goes into the 106 to 212 μm range and there is only a small increase in the smallest fraction measured.

From the preceding results, it can be seen that the method of the present invention is highly effective at agglomerating alumina particles into micro-agglomerates of appropriate size and resistance to attrition to be incorporated into smelting grade alumina. This is achieved using levels of binder much lower than that utilised in the prior art, affording cost savings and industrial hygiene benefits.

It is envisaged that a catalyst metal may be added to the slurry to produce a high surface area catalyst product on an alumina binder.

Modifications and variations such as would be apparent to the skilled addressee are considered to fall within the scope of the present invention.

What is claimed is:

1. A method for the agglomeration of alumina particles, the method characterized by the steps of:
(a) adding a quantity of pseudo-boehmite to a plurality of alumina particles, thereby to form a mixture, and
(b) spray drying the mixture to produce agglomerated granules.

2. A method according to claim 1 characterized in that the pseudo-boehmite is added as an aqueous suspension.

3. A method according to claim 2 characterized in that the aqueous suspension of pseudo-boehmite is formed at a temperature between about 15 and 100° C.

4. A method according to claim 2 or 3 characterized in that the aqueous suspension of pseudo-boehmite is formed at a temperature above about 80° C.

5. A method according to claim 2 characterized in that the aqueous suspension of pseudo-boehmite is formed at a temperature above about 85° C.

6. A method according to any of claims 2 to 5 characterized in that a quantity of acid is added to the aqueous suspension of pseudo-boehmite such that the pH of the suspension is between about 2 and 6.

7. A method according to claim 6 characterized in that a quantity of acid is added to the aqueous suspension of pseudo-boehmite such that the pH of the suspension is approximately 3.

8. A method according to claim 6 or 7 characterized in that the acid is monoprotic.

9. A method according to claim 8 characterized in that the acid is acetic acid.

10. A method according to any of the preceding claims characterized in that, before the step of adding a quantity of pseudo-boehmite to the alumina particles, the alumina particles are comminuted to a D₅₀ of less than 12 μm.

11. A method according to claim 10 characterized in that the alumina particles are comminuted to a D₅₀ of less than about 9 μm.

12. A method according to claim 11 characterized in that before step (a), the alumina particles are communited to a D₅₀ of about 5 μm.

13. A method according to any one of the preceding claims characterized in that a quantity of water is added to the alumina particles to form a slurry, the particles in the slurry then being subjected to grinding.

14. A method according to any one of claims 1 to 12 characterized in that the alumina particles are subjected to dry grinding before a quantity of water is added to form a slurry.

15. A method according to claim 14 characterized in that the quantity of water is provided by way of an aqueous suspension of pseudo-boehmite.

16. A method according to any one of claims 13 to 15 characterized in that the slurry is of high density.

17. A method according to claim 16 characterized in that the slurry comprises at least aboout 50% solids.

18. A method according to claim 16 characterized in that the slurry comprises between about 40 and 60% solids.

19. A method according to any one of claims 13 to 18 characterized in that a viscosity modifier is added to the slurry.

20. A method according to claim 19 characterized in that the viscosity modifier contains one or more of acetic acid, citric acid or a polyacrylate.

21. A method according to claim 19 characterized in that the viscosity modifier is added such that the viscosity of the slurry is less than about 4 cp.

22. A method according to any one of claims 19 to 21 characterized in that the viscosity modifier is acetic acid.

23. A method according to claim 22 characterized in that sufficient acetic acid is introduced such that the concentration of the acetic acid in the slurry is between about 0.2 and 1.5% by weight of the alumina particles.

24. A method according to any one of the preceding claims characterized in that before the quantity of pseudo-boehmite is added to the alumina particles, the method comprises the additional steps of neutralizing, dewatering and washing the alumina particles.

25. A method according to claim 24 characterized in that dewatering is achieved by way of filtration.

26. A method according to claim 24 characterized in that dewatering is achieved by way of centrifugation.

27. A method according to any one of claims 24 to 26 characterized in that carbon dioxide neutralizes the alumina particles.

28. A method according to any one of claims 24 to 27 characterized in that the step of neutralizing, dewatering and washing the alumina particles is carried out before grinding the alumina particles.

29. A method according to any one of the preceding claims characterized by the step of heating the agglomerated granules.

30. A method according to claim 29 characterized in that the agglomerated particles are dehydroxylated by heating to approximately 300° C.

31. A method according to claim 29 characterized in that the agglomerated granules are calcined above 500° C.

32. A method according to claim 1 wherein the quantity of pseudo-boehmite is at least about 0.8 wt %, based on weight of the mixture.

33. A method according to any of the preceding claims wherein the agglomerated granules have a D₅₀ in the range of about 150 to 300 μm.

34. Agglomerated granules produced by the method of any one of claims 1 to 33.
